(19) United States
(12) Patent Application Publication
(10) Pub. No.: US 2022/0377444 A1
(43) Pub. Date: Nov. 24, 2022

(54) SPEAKER

(71) Applicants: Inventec (Pudong) Technology Corporation, Shanghai (CN); INVENTEC CORPORATION, Taipei City (TW)

(72) Inventors: Mu-Heng TSAI, TAIPEI CITY (TW); Yin-Chang CHENG, TAIPEI CITY (TW); Chia-Chen CHEN, TAIPEI CITY (TW); Chi-Zen PENG, TAIPEI CITY (TW)

(21) Appl. No.: 17/338,712

(22) Filed: Jun. 4, 2021

(30) Foreign Application Priority Data
May 20, 2021 (CN) 202110552837.7

(51) Int. Cl. H04R 1/02; G06F 1/16

(52) U.S. Cl. CPC H04R 1/026; G06F 1/1688; H04R 2201/02

(57) ABSTRACT

A speaker includes a rubber cabinet, a driver, and a plastic connection ring. The rubber cabinet is fixed to a case of an electronic device. The rubber cabinet accommodates the driver, and the plastic connection ring is connected between the rubber cabinet and the driver. Moreover, the plastic connection ring surrounds the driver, and the rubber cabinet surrounds the plastic connection ring.

### CROSS-REFERENCE TO RELATED APPLICATION

This application claims priority to China Application Serial Number 202110552837.7, filed May 20, 2021, which is herein incorporated by reference in its entirety.

### BACKGROUND

### Field of Invention

The present invention is related to a speaker.

### Description of Related Art

Speakers are a very common device used to output sound. The function of the speaker is to convert electrical signals into mechanical vibration, thereby causing the surrounding air to change density and produce sound.

In the case of a large speaker, a bass enhancement device, such as a bass reflex and a passive radiator, is generally disposed in the speaker, so as to utilize the phase reversal to change the sound pressure of the low frequency band. Therefore, the bass of the speaker can be efficiently improved.

Together with the development of thin and light speakers in recent times, many kinds of speakers, such as those used in smart phones, tablets, and laptops, have become miniaturized to reduce the occupied volume thereof, in view of the small internal space in such devices. However, if the size of speakers becomes small, the performance thereof will be negatively affected.

Therefore, private companies and academic institutions have invested a considerable amount of money, resources, and time to research speakers, so as to improve the various characteristics thereof.

### SUMMARY

The present disclosure provides a speaker which includes a rubber cabinet, a driver, and a plastic connection ring. The rubber cabinet is fixed to a case of an electronic device. The rubber cabinet accommodates the driver, and the plastic connection ring is connected between the rubber cabinet and the driver. Moreover, the plastic connection ring surrounds the driver, and the rubber cabinet surrounds the plastic connection ring.

In one or more embodiments of the present disclosure, the plastic connection ring includes a plurality of extension arms spaced apart along an outer periphery of the plastic connection ring.

In one or more embodiments of the present disclosure, the extension arms are T-shaped.

In one or more embodiments of the present disclosure, each extension arm has a first portion and a second portion. A width of the second portion is smaller than a width of the first portion, and the first portion is farther from a center of the plastic connection ring than the second portion.

In one or more embodiments of the present disclosure, the rubber cabinet has a bending bottom, and a first portion of the bending bottom is fixed to the case and extends outward from the rubber cabinet.

In one or more embodiments of the present disclosure, the speaker of further includes a double-sided adhesive tape which fixes the bending bottom to the case.

In one or more embodiments of the present disclosure, the rubber cabinet has a bending bottom, and a second portion of the bending bottom is fixed to the case and extend inward from the rubber cabinet.

In one or more embodiments of the present disclosure, the rubber cabinet has a bending bottom, a first portion of the bending bottom is fixed to the case and extends outward from the rubber cabinet, and a second portion of the bending bottom is fixed to the case and extends inward from the rubber cabinet.

In one or more embodiments of the present disclosure, the speaker further includes a double-sided adhesive tape which fixes the bending bottom to the case.

In one or more embodiments of the present disclosure, the rubber cabinet includes a ring-shaped protrusion portion, the plastic connection ring includes a ring-shaped recess, and the protrusion portion is received in the recess.

In one or more embodiments of the present disclosure, the plastic connection ring includes a step-shaped interior edge configured for fixing the driver.

In embodiments of the present disclosure, a speaker with a rubber cabinet is provided, and the rubber cabinet is made of soft material, so as to decrease the needed space thereof. At the same, the rubber cabinet can occupy a greater space under the same accommodating space, and the rubber cabinet can also absorb the sound waves which are generated by a driver of the speaker, thereby preventing the sound waves from resonating with elements of the speaker and producing noise.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a schematic view of an electronic device having a speaker mounted therein in accordance with some embodiments of the present disclosure;

FIG. 2 illustrates a schematic view of the speaker in accordance with some embodiments of the present disclosure;

FIG. 3 illustrates a bottom view of a rubber cabinet, a driver, and a plastic connection ring in accordance with some embodiments of the present disclosure;

FIG. 4 illustrates a cross-sectional view taken along line A-A in FIG. 2;

FIG. 5 illustrates a schematic view of a plastic connection ring in accordance with some embodiments of the present disclosure;

FIG. 6 illustrates another schematic view of the plastic connection ring taken from a view different from FIG. 5;

FIG. 7 illustrates another cross-sectional view taken along line A-A in FIG. 2 in accordance with other embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

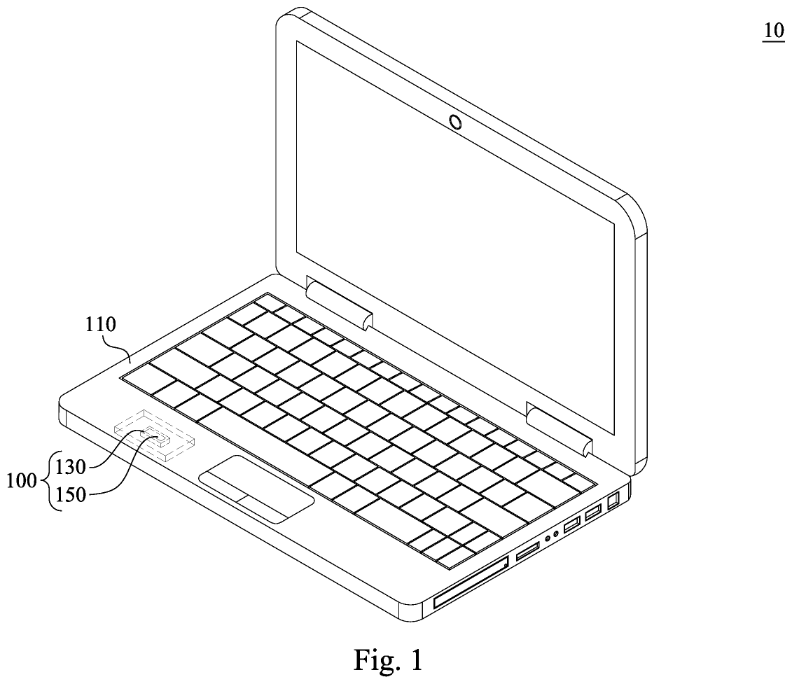

Reference is made to FIG. 1. FIG. 1 illustrates a schematic view of an electronic device 10 having a speaker 100 mounted therein. The electronic device 10 may be a laptop computer, a tablet computer, or a mobile device (e.g., a mobile phone), and the present disclosure is not limited in this respect. The electronic device 10 has a case 110 forming an accommodating space, and a rubber cabinet 130 and a driver 150 are disposed inside the case 110 for generating various types of sounds.

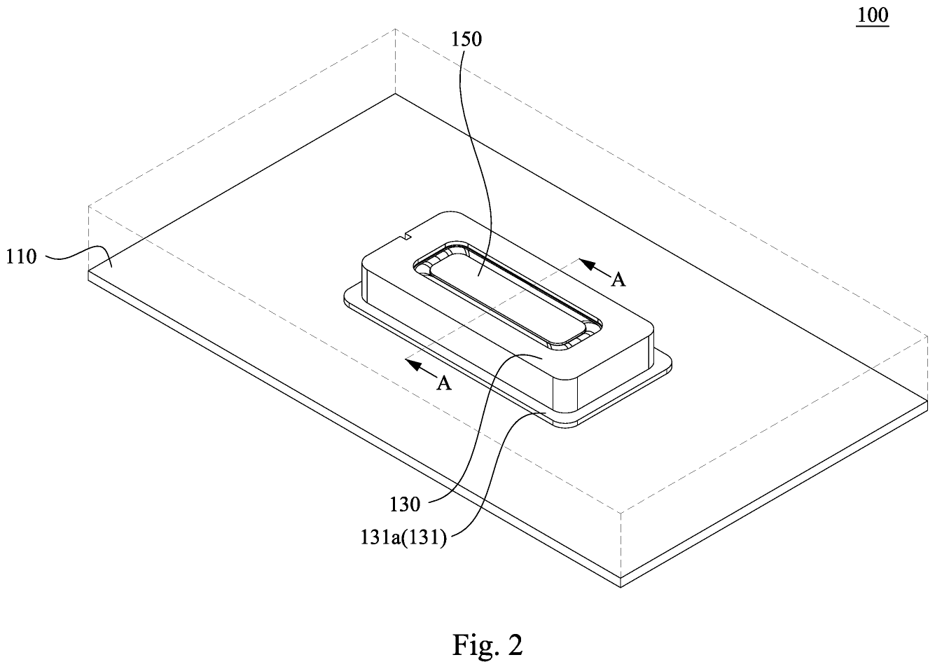

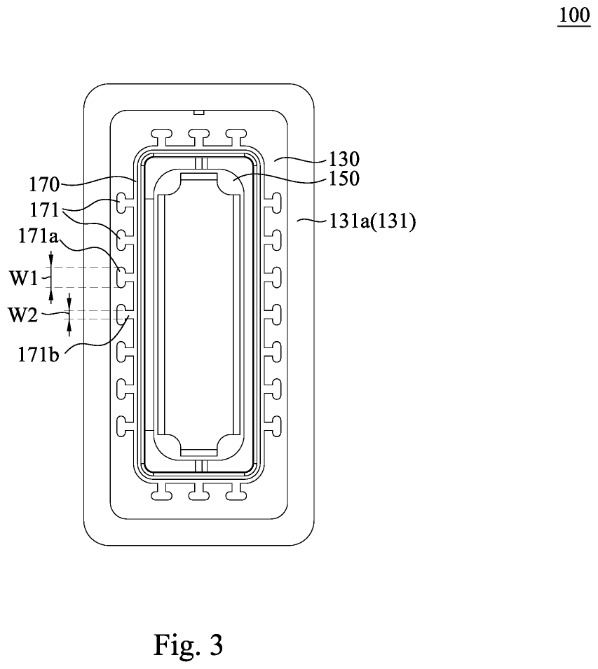

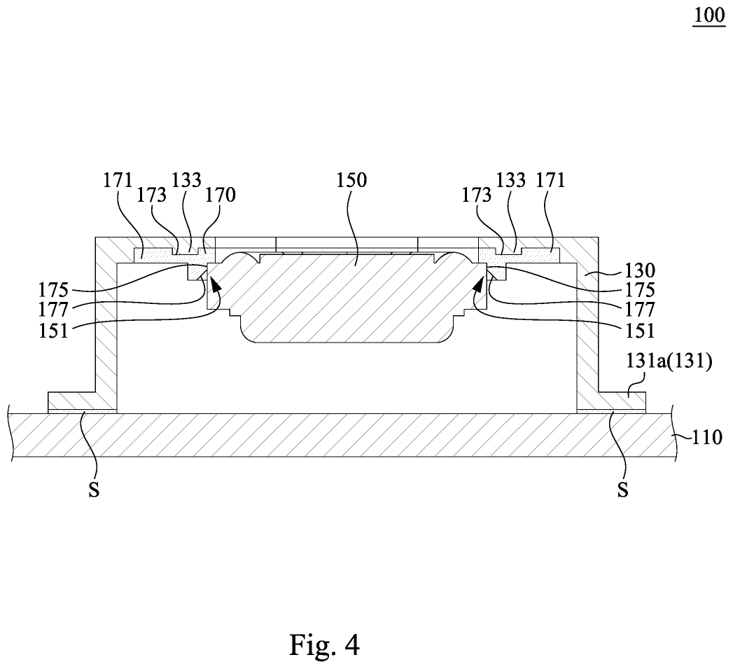

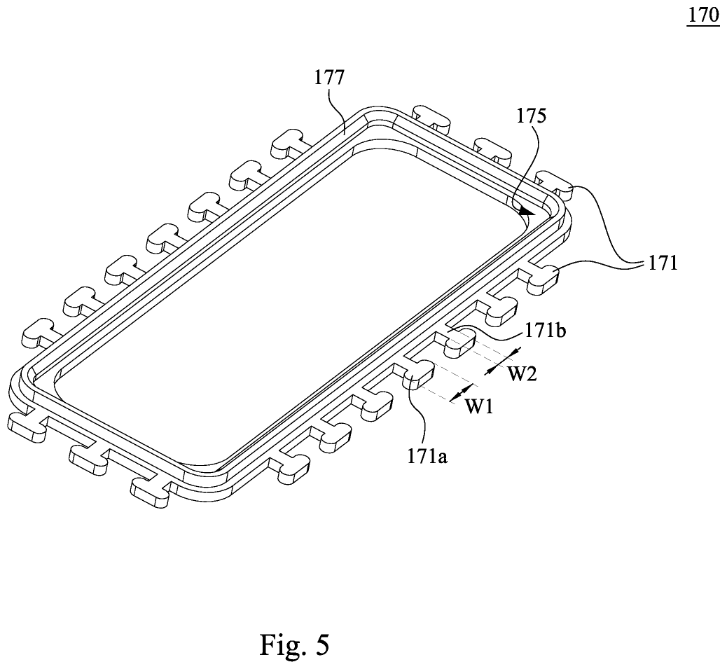

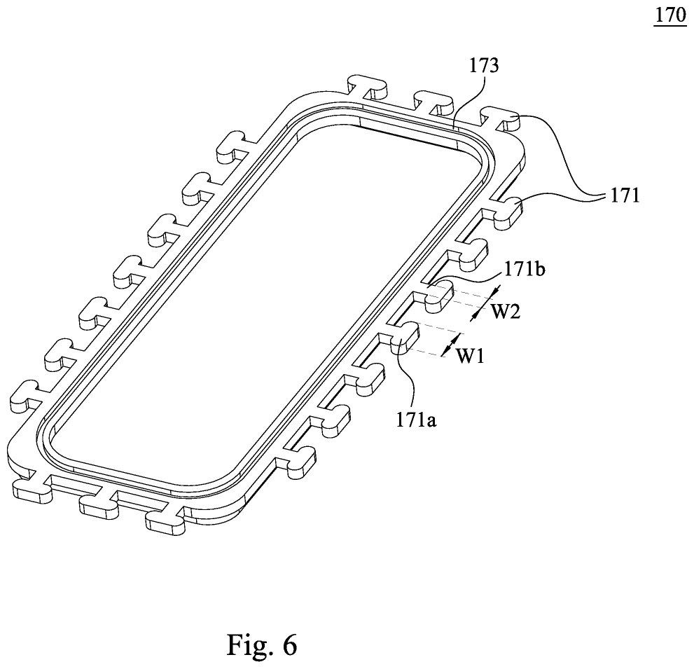

Reference is made to FIGS. 2-6. FIG. 2 illustrates a schematic view of the speaker 100. FIG. 3 illustrates a bottom view of the rubber cabinet 130, the driver 150, and a plastic connection ring 170. FIG. 4 illustrates a cross-sectional view taken along line A-A in FIG. 2. FIG. 5 illustrates a schematic view of the plastic connection ring 170. FIG. 6 illustrates another schematic view of the plastic connection ring 170 taken from a view different from FIG. 5. In one or more embodiments of the present disclosure, the rubber cabinet 130 is fixed to the case 110, and the rubber cabinet 130 accommodates the driver 150. Moreover, the plastic connection ring 170 is connected between the rubber cabinet 130 and the driver 150. The plastic connection ring 170 surrounds the driver 150, and the rubber cabinet 130 surrounds the plastic connection ring 170. In addition, the plastic connection ring 170 includes a plurality of extension arms 171, and the extension arms 171 are spaced apart along an outer periphery of the plastic connection ring 170. Moreover, the extension arms 171 are substantially T-shaped or mushroom-shaped, and thus the plastic connection ring 170 can be stably fixed to the rubber cabinet 130 by the extension arms 171. The present disclosure is not limited in this respect. In some embodiments, each extension arm 171 has a first portion 171a and a second portion 171b, and the first portion 171a has a first width W1 greater than a second width W2 of the second portion 171b. The first portion 171a is farther from a center of the plastic connection ring 170 than the second portion 171b, so the plastic connection ring 170 can be stably fixed to the rubber cabinet 130. Since the rubber cabinet 130 is made from rubber, a smaller assembly gap with adjacent elements can be maintained. Moreover, the rubber cabinet 130 can occupy a greater volume under the same accommodating space, and the material of the rubber cabinet 130 can further efficiently absorb sound waves generated by the driver 150, thereby preventing the sound waves from resonating with elements of the speaker 100 and generating noise.

During actual assembly, since it is hard to fix the rubber cabinet 130 to other elements using general adhesive, spot glue and ultraviolet resin can be used to first fix the driver 150 to the plastic connection ring 170. Moreover, an injection molding process can directly form rubber on the plastic connection ring 170, and thus the rubber cabinet 130 can be obtained. The rubber cabinet 130 is then fixed to and disposed inside the case 110, such that the speaker 100 can be obtained. The present disclosure is not limited in this respect.

In one or more embodiments of the present disclosure, the rubber cabinet 130 includes a bending bottom 131, and a first portion 131a of the bending bottom 131 is fixed to the case 110 and extends outward from the rubber cabinet 130. Moreover, the speaker 100 includes a double-sided adhesive tape S, in which the double-sided adhesive tape S is configured for fixing the bending bottom 131 to the case 110. In practical application, the double-sided adhesive tape S can stably fix the rubber cabinet 130 to other objects. The double-sided adhesive tape S can be directly connected between the case 110 and the rubber cabinet 130. In addition, the double-sided adhesive tape S can be a double-sided acrylic tape or a double-sided silicon tape, and the present disclosure is not limited in this respect.

In one or more embodiments of the present disclosure, the plastic connection ring 170 can be made of thermosoftening plastic or thermosetting plastic, in which an injection process can be performed to manufacture the plastic connection ring 170. The present disclosure is not limited in this respect. Moreover, the plastic connection ring 170 can include a circular ring structure, a triangular ring structure, a square ring structure, or any polygonal ring structure. The “ring” described in the present disclosure can refer to an open surrounding structure or a closed surrounding structure, and the “ring” is not limited any shape. The rubber cabinet 130 includes a ring-shaped protrusion portion 133, and the plastic connection ring 170 includes a ring-shaped recess 173. The ring-shaped recess 173 can receive the ring-shaped protrusion portion 133. In some embodiments of the present disclosure, the ring-shaped recess 173 has a U-shaped cross section, and the rubber cabinet 130 and the plastic connection ring 170 can be stably connected. In addition, the ring-shaped protrusion portion 133 can include a circular ring, a triangular ring, a square ring, or any polygonal ring. The ring-shaped recess 173 can be a circular ring recess, a triangle ring recess, a square ring recess, or any a polygonal ring. The present disclosure is not limited in this respect.

In one or more embodiments of the present disclosure, the plastic connection ring 170 includes a step-shaped interior edge 175, and the step-shaped interior edge 175 is ring-shaped and configured for fixing the driver 150. The step-shaped interior edge 175 can provide contacting surfaces in different directions for fixing the driver 150, and the driver 150 has an edge angle 151 corresponding in shape to the step-shaped interior edge 175. Therefore, the driver 150 is in close contact with the step-shaped interior edge 175 via the edge angle 151, and there is good stability between the plastic connection ring 170 and the driver 150. The present disclosure is not limited in this respect.

In one or more embodiments of the present disclosure, the plastic connection ring 170 includes a ring-shaped slope 177 which is beneath the step-shaped interior edge 175. When the plastic connection ring 170 fixes the driver 150 via the step-shaped interior edge 175, the circular slope 177 gradually extends downward and backward from the driver 150. This allows for convenience when demolding the plastic connection ring 170 after the injection process, and the driver 150 is more easily separated from the plastic connection ring 170 if needed. The present disclosure is not limited in this respect.

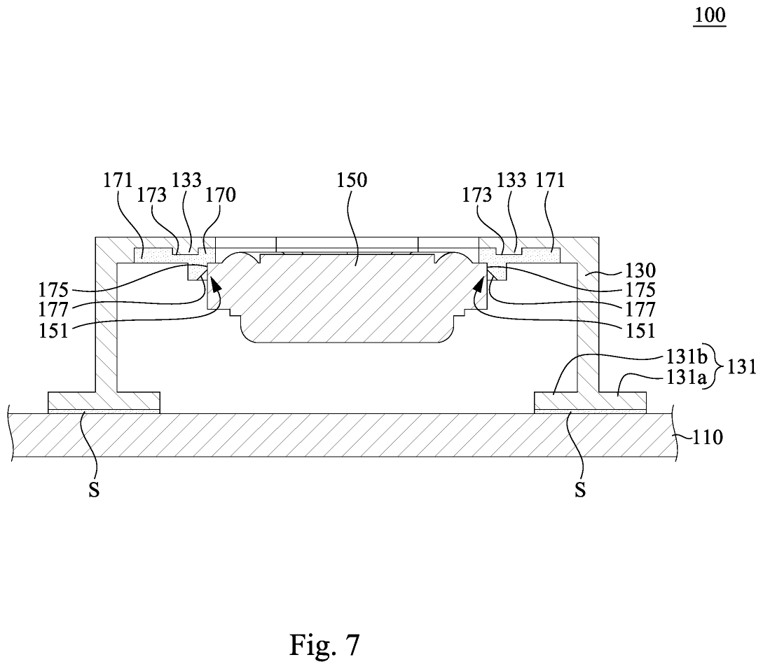

FIG. 7 illustrates another cross-sectional view taken along line A-A in FIG. 2 in accordance with other embodiments of the present disclosure. In some embodiments of the present disclosure, the rubber cabinet 130 includes the bending bottom 131, in which a first portion 131a of the bending bottom 131 is fixed to the case 110a and extends outward from the rubber cabinet 130, and a second portion 131b of the bending bottom 131 is fixed to the case 110 and extends inward from the rubber cabinet 130. In short, the bending bottom 131 has the first portion 131a and the second portion 131b which respectively extend outward and inward from the rubber cabinet 130, and thus the first portion 131a and the second portion 131b respectively extend in two opposite directions. Therefore, the bending bottom 131 has a significant contacting surface, and the rubber cabinet 130 can be stably fixed to the case 110. The present disclosure is not limited in this respect.

In embodiments of the present disclosure, a speaker with a rubber cabinet is provided, and the rubber cabinet is made of soft material, so as to decrease the needed space thereof. At the same time, the rubber cabinet can occupy a greater space under the same accommodating space, and the rubber cabinet can also absorb sound waves which are generated by a driver of the speaker, thereby preventing the sound waves from resonating with elements of the speaker and producing noise.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A speaker comprising:
a rubber cabinet fixed to a case of an electronic device;
a driver, wherein the rubber cabinet accommodates the driver; and
a plastic connection ring connected between the rubber cabinet and the driver, wherein the plastic connection ring surrounds the driver, and the rubber cabinet surrounds the plastic connection ring.

2. The speaker of claim 1, wherein the plastic connection ring comprises a plurality of extension arms spaced apart along an outer periphery of the plastic connection ring.

3. The speaker of claim 2, wherein the extension arms are T-shaped.

4. The speaker of claim 1, wherein each extension arm has a first portion and a second portion, and a width of the second portion is smaller than a width of the first portion, and the first portion is farther from a center of the plastic connection ring than the second portion.

5. The speaker of claim 1, wherein the rubber cabinet has a bending bottom, and a first portion of the bending bottom is fixed to the case and extends outward from the rubber cabinet.

6. The speaker of claim 5, further comprising a double-sided adhesive tape which fixes the bending bottom to the case.

7. The speaker of claim 1, wherein the rubber cabinet has a bending bottom, and a second portion of the bending bottom is fixed to the case and extends inward from the rubber cabinet.

8. The speaker of claim 7, further comprising a double-sided adhesive tape which fixes the bending bottom to the case.

9. The speaker of claim 1, wherein the rubber cabinet has a bending bottom, a first portion of the bending bottom joins the case and extends outward from the rubber cabinet, and a second portion of the bending bottom joins the case and extends inward from the rubber cabinet.

10. The speaker of claim 9, further comprising a double-sided adhesive tape which fixes the bending bottom to the case.

11. The speaker of claim 1, wherein the rubber cabinet comprises a ring-shaped protrusion portion, and the plastic connection ring comprises a ring-shaped recess, wherein the protrusion portion is received in the recess.

12. The speaker of claim 1, wherein the plastic connection ring comprises a step-shaped interior edge configured for fixing the driver.
